(19) United States
(12) Patent Application Publication
(10) Pub. No.: US 2003/0185137 A1
(43) Pub. Date: Oct. 2, 2003

(54) Optical pick-up apparatus and optical disc unit therefor

(76) Inventors: Shogo Horinouchi, Fukuoka (JP); Hiroshi Goto, Munakata (JP); Taiichi Mori, Koga (JP); Takashi Haruguchi, Fukuoka (JP); Hisayoshi Takamure, Onojo (JP); Shinji Tanaka, Chikushino (JP); Junya Aso, Fukuoka (JP); Masaharu Fukakusa, Kobayashi (JP); Toshihiro Koga, Ueki (JP); Mitsuhiro Matsumoto, Arao (JP); Fuminobu Furukawa, Onojo (JP)

Correspondence Address: STEVENS, DAVIS, MILLER & MOSHER, L.L.P., Suite 850, 1615 L Street, N.W., Washington, DC, 20036, US

(21) Appl. No.: 10/396,327

(22) Filed: Mar. 26, 2003

(30) Foreign Application Priority Data
Mar. 29, 2002 (JP) 2002-096525

(51) Int. Cl. G11B 7/135

(52) U.S. Cl. 369/112.22; 369/112.28

(57) ABSTRACT

Provided are a thin optical pick-up apparatus which can record and reproduce data to and from both high recording density disc and low recording density disc, and a thin optical disc unit using this optical pick-up apparatus. The optical pick-up apparatus comprises a short wave LDA 11, a long wave LDAB 12, a beam splitter 41, a riser prism 23 for turning an optical axis into an optical axis perpendicular to the optical disc, a composite filter 33 being integrally incorporated with the objective lens 32 while a surface of the composite filter 33 is opposed to an oblique surface of the riser prism 23 in parallel with each other.

### BACKGROUND OF THE INVENTION

The present invention relates to an optical pick-up apparatus adapted to be used for recording and reproducing data onto and from an optical recording medium, and an optical disc unit using this optical pick-up apparatus.

### FIELD OF THE INVENTION

These years, the development of computer devices is marvelous. Meanwhile, optical recording mediums have been wide-spread and widely used as data storage units in computer devices since it has a large memory capacity and it can be conveniently used. Further, as the computer devices have been miniaturized, optical disc units dealing with optical recording mediums have been relatively miniaturized.

The miniaturization of an pick-up apparatus is one of important factors for the miniaturization of the optical disc units. Accordingly, there have been presented various proposals for the miniaturization. For example, there have been reported such configuration that a triangular riser prism is used so as to provide a thin optical disc unit (refer to, for example, JP-A-11-134701), and that wave front aberration is improved (refer to JP-A-2000-195985).

Simultaneously, optical discs as the optical recording mediums have been also remarkably advanced. That is, CD-ROM have been wide-spread as a low recording density optical disc, and CD-R/RW have also been developed as a recording type. In addition, a high recording density optical disc has been developed, and there have been wide-spread DVD-ROM as a reproduction system have been developed, and then DVD-R/RW and DVD-RAM have been wide-spread.

It is noted that the optical disc in the present invention is a general term of recording mediums on and from which data can be recorded and reproduced, and should be widely defined, irrespective of difference in degrees of recording mediums, wavelengths of light beams, whether magnetisms are used or not, and loading conditions as to whether it is accommodated in a jacket or not, and further, irrespective of degrees of outer diameters, and external shapes such as a name card-like rectangular shape.

However, since several kinds of recording mediums have been wide-spread, there have been commercially demanded acceptability of various recording mediums and thinning of the optical disc units as mobile type computer devices have been wide-spread.

### SUMMARY OF THE INVENTION

The present invention is devised in order to satisfy the above-mentioned commercial demands, and accordingly, an object of the present invention is to provide a thin optical pick-up apparatus which can record and reproduce data to and from both low recording density optical disc and high recording density optical disc, and a thin optical disc unit using this optical pick-up unit.

To the end, according to the present invention, there is provided an optical pick-up apparatus comprising a first light source for emitting a firs leaser beam having a first wavelength and an optical axis, a second light source for emitting a second laser beam having a second wavelength and an optical axis, a beam splitter means for guiding the first and second optical beams so as to allow the optical axes thereof to be a common optical axis, and a riser prism for changing the common optical axis into an optical axis perpendicular to an optical disc, and an objective lens for focusing the first leaser beam and the second laser beam onto the optical disc, characterized in that a composite filter integrally incorporated with the objective lens, for controlling beam diameters and polarizing directions of the first lease beam and the second laser beam is integrally incorporated with the objective lens, and a surface of the composite filter is arranged so as to be parallel with an oblique surface of the riser prism.

Thus, according to the present invention, there can be provided a thin optical pick-up apparatus which can record and reproduce data onto and from both low and high recording density optical discs, and a thin optical disc unit using this optical pick-up apparatus.

### BRIEF DESCRIPTION OF THE DRAWINGS:

FIG. 1 is a perspective view illustrating an optical pick-up in its entirety;

FIG. 2 is an exploded perspective view illustrating a unit constituting an LDB;

FIG. 3 is a view for explaining a relationship between a riser prism and an objective lens;

FIG. 4 is view for explaining operation of a short wavelength beam system;

FIGS. 5a and 5b are views for explaining operations of an integrated prism;

FIG. 6 is a view for explaining operation of a long wavelength beam system; and

FIG. 7 is a view for explaining an embodiment 2 with respect to a beam splitter.

### DESCRIPTION OF THE PREFERRED EMBODIMENTS

Explanation will be hereinbelow made of embodiments of the present invention with reference to the accompanying drawings. It is noted that a DVD optical disc (which will be hereinbelow abbreviated as DVD) as an example of high recording density optical discs, and a CD optical disc (which will be hereinbelow abbreviated as CD) as an example of low recording density optical discs are used throughout the following explanation. However, it should not be construed that the present invention is limited only to these mediums. For example, a DVD optical disc for a red wavelength beam system may be used as a low recording density optical while a DVD optical disc for a blue wavelength system may be used as a high recording density optical disc.

(Embodiment 1)

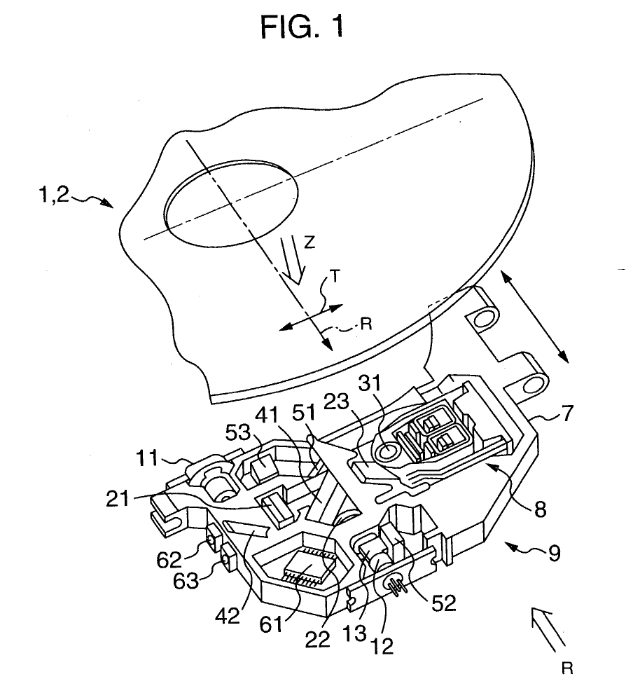

Referring to FIG. 1 which is a perspective view illustrating an optical pick-up in its entirety, there are shown a DVD (DVD optical disc) 1 and a CD (CD optical disc) 2, both being formed in a disc-like shape and also formed thereon with concentric (precisely spiral) data tracks. As viewed on the optical disc side, the extending direction of the data tracks will be referred to as a tangential direction T while the radial direction R will be referred to as a tracking direction.

The optical pick-up which is generally denoted by reference numeral 9, is composed of the following components: an LDA (semiconductor laser A) 11 serving as a DVD light source for emitting a short wave laser beam, an LDB (semiconductor laser B) 12 serving as a CD light source for emitting a long wave laser beam. The short wave laser beam emitted from the LDA 11 is deflected in its direction by a mirror 42, and is then incident upon a CLA (collimator lens A) 21. The short-wave light beam which has been converted from diffused light into parallel light, is incident upon a beam splitter 41. The long-wave laser beam emerged from the LDB 12 passes through an integrated prism 13 and is then incident upon a CLB 22. The long-wave laser beam which has been converted from diffused light into parallel light by the CLB 22 is also incident upon the beam-splitter 41.

The beam splitter 41 is capable of transmitting or reflecting light, depending upon a light wavelength and a polarizing direction so that, for example, P-polarized light as to the short wave laser beam is transmitted therethrough, but S-polarized light is reflected thereby, or the long wave laser beam is totally reflected. Specifically, for example, it is materialized by such a configuration that a parallel plate made of a highly ltransparent resin material or optical glass (which will be hereinbelow abbreviated as a light transmitting member) is coated over its one surface with an optical thin film having a function of transmitting or reflecting light, depending upon a light wavelength and a polarizing direction.

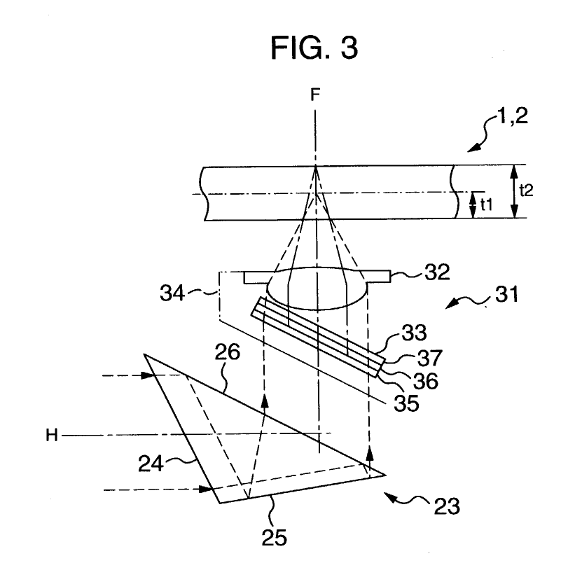

Both long and short wave laser beams incident upon the beam splitter 41 are guided along one and the same optical axis H (refer to FIG. 3), and is then incident upon a riser prism 23 up to which both short and long wave laser beams travel on an optical path which is substantially parallel with the surface of the optical disc. Both laser beams are reflected in the riser prism 23 so as to change its course while its light intensity distribution of FFP (far-field pattern) is shaped so as to have a circular shape, and are then emerged therefrom, perpendicular to the surface of the optical disc (as indicated by F in FIG. 3).

Both short and long wave laser beams emerged from the riser prism 23 are incident upon an objective lens 31 by which they are set so as to have diameters depending upon their wavelengths and are then converted into converged light beams that are incident upon the surface of the optical disc.

Further, there are shown a PDA (photo detector A as a light receiving means) 51, for receiving the light beams emitted from the LDA 11 and the LDB 12, in part which is extracted by the beam splitter 41, the light detected by the PDA 51 being fed back for controlling the power of light emission from the LDA 11 and the LDB 12 by means of a control IC 61, and an HFM (high frequency module) 53 for high frequency-modulating the LDA 11. It is noted that the HFM 53 may be packaged together with the control IC 61. A VOLA (volume A) 62 and a VOLB (volume B) 63 are variable resistors (volumes) for adjusting the powers of light emission by the LDA 11 and LDB 12, respectively.

A reflected return light beam containing a signal component reflected by a recording layer of the optical disc, is incident upon the beam splitter 41 after passing through the above-mentioned optical components in the order reverse to the mentioned order of the above-mentioned components. Both short and long wave light beams are again reflected by the beam splitter 41. Thus, the reflected light beam containing a signal component reflected by the recording layer of the optical disc is led through the CLB 22 and the integrated prism 13 and is then detected by the PDB 52 which is a photodetector B as a light receiving means, and which can detect the return light containing signals components reflected by recording layers of respective optical discs having different specifications, in accordance with their respective wavelengths.

Meanwhile, the actuator 8 support the objective lens unit 31 which is therefore displaceable in order to focus light beams onto the data recording layer of the optical disc and to trace a micro track. The components as stated above, are integrated on the carriage 7. Thus, a displacement exceeding a trace control range in the tracking direction is adapted by displacing the carriage 7 in its entirety in the radial direction of the optical disc.

Next, explanation will be made of the components successively. The LDA 11 is a semiconductor laser A for a light source for emitting a short wave laser beam. Even with a thin pick-up apparatus, there is used a general-purpose semiconductor laser which are commercially available in view of both shape and characteristic.

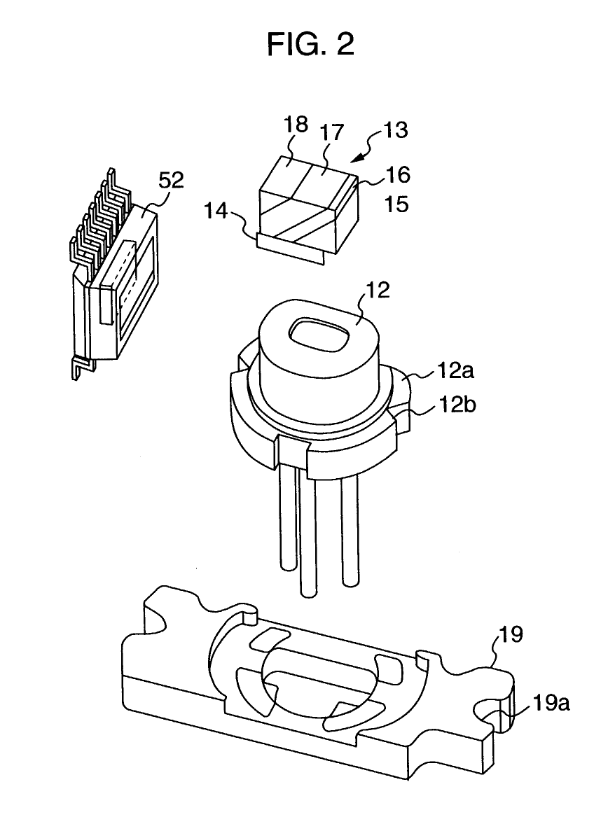

Referring to FIG. 2 which is an exploded perspective view illustrating a unit constituting the LDB 12, the LDB 12 is a semiconductor laser B for a CD light source which emits a long wave laser beam, and similar to the LDA 11, a general purpose semiconductor laser which is commercial available is used as the LDB 12. Accordingly, in addiction to the LDA 11, the most expensive indispensable component in a pick-up apparatus can be acquired at a most inexpensive cost, thereby it is possible to provide an inexpensive optical pick-up apparatus.

Further, the LDB 12 constitutes a single unit including the integrated prism 13, the base member 19 and the PDB 52. They may be integrally constituted together through the intermediary of a member for defining the positions of the components, for which the carriage 7 may be used, or they may be fixed together, direct to one another. In general, the position of the light emitting point (which is not shown) of the LDB 12 is such that the center point of thereof is coincident with the center point of the circular outer periphery of a stem 12a. The height of the light emitting point in the direction of the optical axis is defined by a value measured from the upper surface of the stem 12a. The polarizing surface of the emitted light beam is defined by an angle (which is normally parallel) to a phantom line connecting markers 12b (V-like positioning grooves) formed in the stem 12a.

The base member 19 is formed therein with base markers (V-like positioning groove) 19a. The assembling is made such as to align the phantom line connecting between the base markers 19a with the phantom line connecting between the makers 12b in order that the polarizing surface of the emitted light beam can be displayed also on the base member 19. The base member 19 is made of a metal material which is selected from a group consisting of Al, Zn, Fe and brass, and which is readily available and which is excellent in heat conductivity and workability. Radiation of heat from the LDB 12 can be effectively promoted through the stem 12a and the base member 19. Further, instead of the stem 12a, the base member 19 is used so as to simply attach the LDB 12 to the associated member for attachment (which is the carriage 7 in this embodiment of the present invention). Because, with no restraint to the shape of the stem 12a, the structure can be suitably adapted to the shape of the attaching position of the carriage 7.

The integrated prism 13 is composed of first to five light conductive members which are made of highly light transparent resin or optical glass. Inter alia, optical glass SFL-1.6 or BK-7 has a high refractive index, and accordingly, a large design margin can be taken for the diffractive grating and the film so as to have such a characteristic that a wavelength shift caused upon light transmission can hardly be caused. Among all, BK-7-1.5 is very convenient since it is easily available and excellent in workability.

The first light conductive member 14 is formed of a parallel plate formed thereon with a diffractive grating for diffracting the light beam emitted from the LDB 12. Thus obtained 0-order light beam and ±1-order light beams are used to produce main and auxiliary beams (which will be referred to as 3 beams) adapted to be used for tracking control.

The second light conductive member 15 is formed in a substantially triangular prism shape, having a substantially right triangular sectional shape so as to have a substantially right angle shape surface formed thereon with a predetermined reflection surface which has such a selective function that the three long wave beams for CD are transmitted but a short wave return beam for DVD is reflected. For example, it may be either a polarized beam splitter film or a wave selecting film.

The third light conductive member is formed of a substantially trapezoidal prism, having a substantially trapezoidal sectional shape and having opposed parallel surfaces one of which is joined to the second light conductive member 15 and the other one of which is formed thereon with a predetermined splitting surface. This splitting surface has such a selective separating function that long wave three beams for CD are transmitted while a long wave return beam for CD is reflected, and a short wave return beams for DVD is transmitted. For example, it may be a polarized beam splitter film additionally having a wave selecting function.

The fourth light conductive member 17 is also formed in a substantially trapezoidal prism shape, having a substantially trapezoidal cross-sectional shape and having opposed parallel surfaces one of which is jointed to the third light conductive member 16 and the other one of which is formed thereon with a predetermined diffractive grating that serves as a reflection type diffractive grating for producing a signal detecting light beam with respect to a long wave return beam for CD.

The fifth light conductive member 18 is formed in a substantially triangular prism, having a right triangular sectional shape so as to have right angle surfaces serving as reference surfaces for the integrated prism 13. It is noted that these light conductive members and film structures or diffractive gratings formed on the surfaces thereof are disclosed in JP-B2-280293, JP-B2-3085148 and JP-A-2001-312835 in detail, and accordingly, the contents of these documents are incorporated by quotation in this specification in order to avoid duplicate the explanation thereto.

Referring to FIG. 3 which is a view for explaining a relationship between the riser prism and the objective lens unit, observing the actuator 8 part in the radial direction (indicated by R), and which is a partially enlarged view for facilitating the understanding of the structure, the riser prism 23 is formed in a triangular prism shape, having a substantially isosceles triangular cross-sectional shape with an obtuse apex. Both long and short wave laser beams are led by the beam splitter 41 along one and the same optical axis H. This prism 23 has surfaces which define sides and which are arranged so as to have predetermined angles with respect to the optical axis H.

A parallel light beam having entered into the riser prism 23 through a first oblique surface 24 is diffracted and then advances. When it comes to a third oblique surface 26, it is totally reflected inward. When it comes to a second oblique surface 25, it is again reflected inward. When it again comes to the third inclined surface 26, it is refracted and transmitted therethrough, and advances toward the objective lens unit 31 from the third oblique surface of the riser prism 23.

At this time, by making the incident angle of the light beam on the first oblique surface 24 different from the emergent angle thereof at the third oblique surface 26, the riser prism 23 can serve as an anamorphic prism. That is, FFPs (Far Field Patterns) of the LDA 11 and the LDB 12 have elliptic intensity distributions due to anisotropy of the radiant emission angle of a semiconductor laser, but since they passe through the riser prism 23, they can be converted into those having substantially circular intensity distributions.

Thus, the laser beam emitted from a semiconductor laser can be focused into a micro spot. Inter alia, a laser beam emitted for recording a short wave laser beam of the LDA 11 is perfectly used for formation of a recording spot in its entirety, and accordingly, no high power semiconductor laser is required for the LDA 11, but a general purpose semiconductor laser can be used. Thus, it is possible to procure a necessary component which is most expensive among the components of the pick-up apparatus, at a lowest cost, thereby it is possible to offer an inexpensive optical pick-up apparatus.

Referring again to FIG. 3, the objective lens unit 31 consists of an objective lens 32 and a composite filter 33 which are integrally incorporated with the lens holder 34. The lens holder 34 is supported by the actuator 34 so as to be slighly displaceable.

The DVD 1 is formed therein with a recording layer at a depth t1=0.6 mm measured from the front surface (lower surface) thereof. Meanwhile, the CD is formed therein with a recording layer at a depth t2=1.2 mm measured from the front surface thereof. Accordingly, the objective lens 32 focuses parallel light beams having one and the same optical axis F onto the recording layers of the discs, that is, the short wave laser beam for DVD 1 being focused onto the recording layer having a depth of 0.6 mm while the long wave laser beam for CD is focused onto the recording layer having the depth of 1.2 mm. Thus, even though the wavelengths of the light sources and the depths of the mediums to the recording layers are different from each other, the objective lens can perform its function, appropriately. That is, the objective lens 32 serves as the so-called special objective lens.

The composite filter 33 is composed of an aperture filter 35, a diffraction grating 36 and a quarter wave plate 32 which are arranged in the mentioned order as viewed from the side near to the light source, which are integrally incorporated with one another, and which are arranged in the lens holder 34 together with the objective lens 32. The aperture filter 35 is adapted to control the diameter of a laser beam passing therethrough so as to satisfy both specifications of the DVD 1 and CD 2 with commonly using the single objective lens 32. That is, it allows the DVD short wave laser beam in an entire range to path therethrough, as indicated by the dotted line so as to obtain an aperture number (which will be hereinbelow abbreviated as NA) of 0.6. Meanwhile, it allows the CD long wave laser beam in a range of the center part to pass therethrough so as to obtain a NA of 0.50. At this time, light in the peripheral part is absorbed (or reflected) by the material of the aperture filter 35.

The diffraction grating 36 is a transmission grating having a polarization-dependability, which is formed by etching a transparent resin material or an optical crystal having an optical isotropy. In this embodiment, a grating depth is set so that it functions as the polarization-dependable transmission grating for the DVD short wave laser beam, and dose not function as the grating for the CD long wave laser beam but as a transparent member since the CD long wave laser beam produces a signal detection light beam through the intermediary of a reflection grating provided in the fourth member 17, as mentioned above.

The quarter wave plate 37 is desired with a wavelength intermediate between the DVD short wavelength and the CD long wavelength, and serves for both laser beams, substantially.

Thus, if the selectively polarizing direction of the above-mentioned diffraction grating 36, and the linear polarization of the LDA 11, and the linear polarization (for example, P-polarization) are orthogonal to one another, the light beam directed toward the optical disc from the light source (which will be abbreviated as an outgoing light beam) transmits through the diffraction grating 36 without being affected by the later, and is then incident upon the quarter wave plate 37. Though this quarter wave plate 37, the light beam is turned into a circularly polarized light beam whose phase is turned by 90 deg. from that of the linearly polarized outgoing light beam, and is then focused onto the recording layer of the optical disc.

A light beam reflected from the recording layer of the optical disc (which will be abbreviated as an incoming light beam) reversely passes through the objective lens 32 and then comes to the quarter wave plate 37. Through this quarter wave plate 37, the circularly polarized incoming light beam is turned into a linearly polarized light beam (for example, S-polarized light beam) whose phase is turned by 90 deg. from the linear polarization (P-polarization) of the outgoing light beam, corresponding to the above-mentioned selective polarizing direction. Thus, the DVD short wave incoming light beam is subjected to diffracting action by the diffraction grating 36, and then emerges from the composite filter 33.

It is noted that the objective lens 32 and the composite filter 33 are integrally incorporated with the lens holder 33, and accordingly, the best positional relationship between the objective lens 32 and the composite filter 33 can be maintained even though the objective lens 32 carries out a focusing shift or a tracking shift, thereby it is possible to constitute an optical pick-up apparatus which can hardly be affected by such a lens shift. Further, since the third oblique surface 26 of the riser prism 23 and the composite filter 33 are arranged in parallel with each other, being opposed to each other, the objective lens 32 and the composite filter 33 can be arranged being closed to each other, even allowing a focusing shift of the objective lens 32, and accordingly, a thin pick-up apparatus can be materialized.

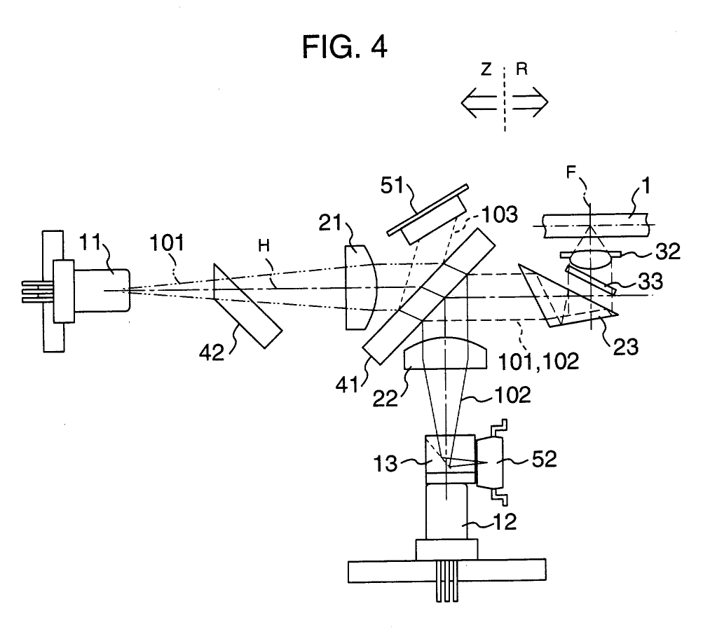

Next, explanation will be made of the operation of the optical pick-up apparatus which is constituted as stated above. In order to facilitate the explanation thereof, the DVD short wave system and the CD long wave system will be respectively explained, separate from each other. FIG. 4 is a view for explaining the operation of the long wave system, and in order to simplify the understanding thereof, the section from the light source to the beam splitter 41 is shown as viewed in the direction Z in FIG. 1, and the section from the beam splitter 41 to the optical disc is shown as viewed in the direction R in FIG. 1.

At first, the DVD short wave system will be explained. The DVD short wave laser beam (which will be abbreviated as the outgoing light beam A 110 and is indicated by the two-dot chain line) is emitted from the LDA 11 and is then incident upon the CLA 21 by way of the mirror 42. The outgoing light beam A 101 which has been converted from diffused line into parallel light by the CLA 21 is incident upon the beam splitter 41. The outgoing light beam A 101 which has been refracted and transmitted through the beam splitter 41 is incident upon the riser prism 23. At this time, the outgoing light beam A 101 repeats refraction and reflection as mentioned above, and accordingly, the direction of the optical axis thereof is turned from that of the optical axis H into that of the optical axis F. Simultaneously, the light intensity distribution is changed from an elliptic distribution into a substantially circular distribution due to a ratio between the incident angle at the first oblique surface 24 and an emergent angle at the third oblique surface 26. This conversion rate will be abbreviated as a beam shaping magnification factor.

Further, the outgoing light beam A 101 is incident upon the composite filter 33. At this time, as stated above, the outgoing light beam A 101 is arranged so as to have a beam diameter corresponding to NA=0.6, by the aperture filter 35, then traveling without being affected by the diffraction grating 36, and is turned into a circularly polarized light beam by way of the quarter wave plate 37. Further, the outgoing light beam A 101 with NA=0.6 is incident upon the recording layer of the DVD 1 having a depth of 0.6 mm.

The outgoing light beam A 101 reflected from the recording layer reversely travels through the optical path. That is, it becomes an incoming light beam A 102 (indicated by the solid line). The incoming light beam is again turned into parallel light by the objective lens 32, and is then incident upon the composite filter 33. Then, it passes through the quarter wave plate 37 so that it is turned into a linearly polarized (S-polarized) light beam whose phase is turned by 90 deg., being subjected to action by the diffraction grating 36, and then, the incoming light beam A 102 travels on the optical path, reversely. The optical axis of the incoming light beam A 102 is changed by the riser prism 23 from the optical axis F into the optical axis H.

Since the incoming light beam A 102 is a linearly polarized light beam whose phase is turned by 90 deg. from that of the outgoing light beam A 101, it is reflected by the front surface of the beam splitter 41 so as to be directed to the LDB 12. The incoming light beam A 102 is again turned into a converged light beam by the CLB 22, and is then incident upon the integrated prism 13. That is, since the incoming light beam B 102 is never returned to the starting point of the outgoing light beam A 101, the DVD short wave system is a nonrecursive optical system.

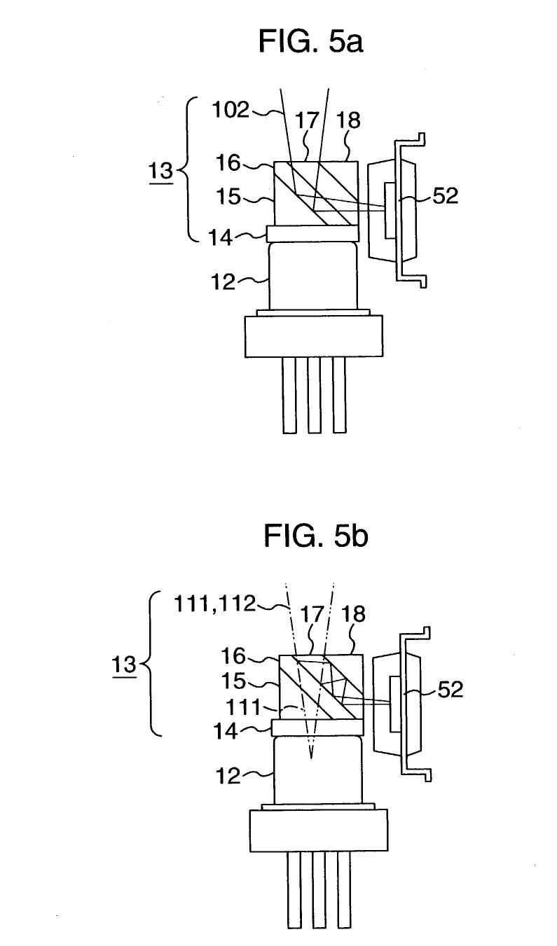

FIGS. 5a and 5b are views for explaining the operation of the integrated prism, and FIG. 5a concerns the behavior of the DVD short wave while FIG. 5b concerns the behavior of the CD long wave. Referring to FIG. 4 and FIG. 5a, the incoming light beam A 102 is incident upon the fourth light conductive member 17 at its end face, transmitting through the third light conductive member 16, and comes to an oblique surface of the second conductive member 15. This oblique surface is for example, a reflective surface having a long wave selection film, and after the reflection, the incoming light beam A 102 again transmits through the third light conductive member 16 and the fourth light conductive member 17, and is incident upon the PDB 52 so as to detect a signal from the DVD 1. It is noted that a sufficient separation effect can be obtained by a slight diffraction effect since the optical path length from the refraction grating 36 to the detecting position PDB 52 is long. That is, since the manufacture of the diffraction grating 36 is simple, it is possible to aim at reducing the cost.

Upon recording onto the DVD 1, it is required that an optical power of the LDA 11 is precisely detected in order to control the optical power. Accordingly, the PDA 51 is arranged in the vicinity of the beam splitter 41 so as to detect a part of the outgoing light beam A 101 reflected from the front surface (incident surface) of the beam splitter 41 when the outgoing light beam A 101 slightly enters into the beam splitter 41. That is, this part is a monitor light beam A 103 which is indicated by the dotted line in FIG. 4.

Further, in the case of using a semiconductor laser having a large anisotropy (aspect ratio) of radiant diffusion angle, the beam shaping multiplication factor as stated above is set to a value between 1.1 to 1.3, and accordingly, a laser beam which has been emitted when a short wave laser beam from the LDA 11 is used for recording, can be perfectly used for formation of a recording spot in its entirety. Upon reproduction of the DVD short wave system, it is important to control the astigmatism. In such a case that the riser prism 23 has a beam shaping function, the astigmatism can be controlled by slightly changing the parallelism of a parallel light beam incident upon the riser prism 23.

More specifically, through slight change by the LDA 11 and the DVD collimator CLA 21, the astigmatism can be adjusted. Further, if the riser prism 23 has not a beam shaping function (beam shaping ratio 1.0), by adding a wedge-like prism to the beam splitter 41, the astigmatism of the DVD short wave system can be adjusted. At this stage, the wedge-like prism serves as an astigmatism correcting member. It is of course possible to integrally incorporate the wedge-like prism with the beam splitter 41.

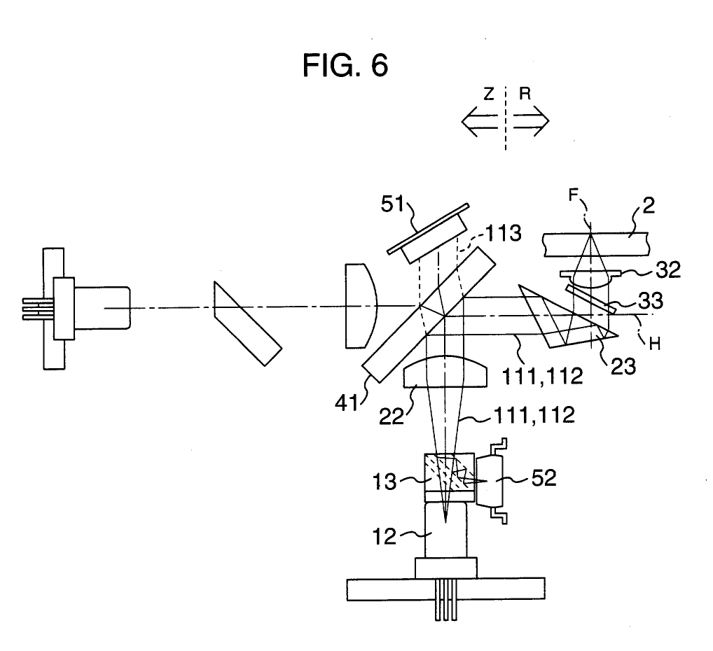

Next, explanation will be made of the CD long wave system referring to FIG. 6 which is a view for explaining the operation of the long wave system. Similar to FIG. 4, the section from the light source to the beam splitter 41 is observed in the direction Z in FIG. 1, and the section from the beam splitter 41 to the optical disc is observed from the direction R in FIG. 1. With reference to FIG. 6 and FIG. 5b, the CD long wave laser beam (which will be abbreviated as an outgoing light beam B 111 and is indicated by the two-dot chain line) produces three beams when it passes through the first light conductive member 14 of the integrated prism 13. Further, the outgoing light beam B 111 transmits successively through the second light conductive member 15, the third light conductive member 16 and the fourth light conductive member 17, and then emerges from the end surface of the fourth light conductive member 14.

The outgoing light beam B 111 emerging from the integrated prism 13 is incident upon the CLB 22 by which it is turned from diffused light into parallel light. Next, the outgoing light beam B 111 is reflected by the front surface of the beam splitter 41, and is incident upon the riser prism 23. At this time, the outgoing light beam B 111 repeats refraction and reflection, similar to the DVD short wave laser beam as stated above, so that its optical axis is changed from the optical axis H into the optical axis F. Further, simultaneously, if the riser prism 23 has a beam shaping function, the light intensity distribution is changed from an elliptic distribution into a circular distribution, depending upon the beam shaping ratio.

Further, the outgoing light beam B 111 is incident upon the composite filter 33. At this time, the outgoing light beam B 111 is limited by the aperture filter 35 so that its beam diameter is set to a predetermined value. The outgoing light beam B 11 has a different wavelength, and accordingly, it travels without being affected by the diffraction grating 36. Next, by way of the quarter wave plate 37, it is turned into a circularly polarized light beam. Further, it is focused onto the CD 2 by the objective lens 32. Further, the outgoing light beam B 111 has a NA=0.50 under the specification, and is focused on the recording layer having a depth of 1.2 mm.

The outgoing light beam B 111 is reflected by the recording layer, and reversely travels on the optical path. That is, it is an incoming light beam B 112 (indicated by the solid line). The incoming light beam B 112 is again turned into a parallel light beam by the objective lens, and is then incident upon the composite filter 33. Through the quarter wave plate 37, it is turned into a linear polarized light beam whose phase is turned by 90 deg. from that of the outgoing light beam B 112, and transmits through the diffraction grating 36, and the incoming light beam B 112 further reversely travel the optical path. The optical axis of the incoming light beam B 112 is changed by the riser prism 23 from the optical axis F into the optical axis H. Further, the incoming light beam B 112 is reflected upon the front surface of the beam splitter 41 and is directed again toward the LDB 12. The incoming light beam B 112 is again turned into a converged light beam by the CLB 22 and is then incident upon the integrated prism 13.

That is, the CD long wave system is a recursive optical system since the incoming light beam comes back to the starting point of the outgoing light beam B 111. Further, the outgoing light beam A 101, the incoming light beam A 102, the outgoing light beam B 111 and the incoming light beam B 112 are all commonly transmitted through the section from the beam splitter 41 to the optical disc by way of the objective lens 32, and accordingly, this section becomes a common optical system and has a common optical axis.

The incoming light beam B 112 is incident upon the fourth light conductive member 17 at its end surface, transmitting through the fourth light conductive member 17, and comes to an oblique surface of the third light conductive member 16. Since this oblique surface is formed thereover with, for example, a polarizing beam splitter film, the incoming light beam B 112 whose polarizing surface is turned by 90 deg. (S-polarization) is reflected. Further, it transmits through the fourth light conductive member 17 and then comes to an oblique surface of the light conductive member 17. Since this oblique surface is formed thereon with a reflection grating, a signal detection light beam is separated and produced from the incoming light beam B 112 which is reflected thereby. The incoming light beam B 112 is again reflected by the oblique surface of the third light conductive member 16, and emerges from the other end surface of the fourth light conductive member 17. The incoming light beam B 112 is incident upon the PDB 52 so as to detect a signal from the CD 2.

Incidentally, upon recording onto the CD 2, it is required to precisely detect an optical power of the LDB 12 so as to control the power. Accordingly, the PDA 51 is also used for the CD 2. When the outgoing light beam B 111 is reflected upon the front surface (reflection surface) of the beam splitter 41, a part of the outgoing light beam B 111 which slightly enters into the beam splitter 41 is detected. That is, it is a monitor light beam B 113 which is indicated by the dotted line in FIG. 6. Thus, also in the CD wave system, a precise optical power is detected so as to control the optical power.

(Embodiment 2)

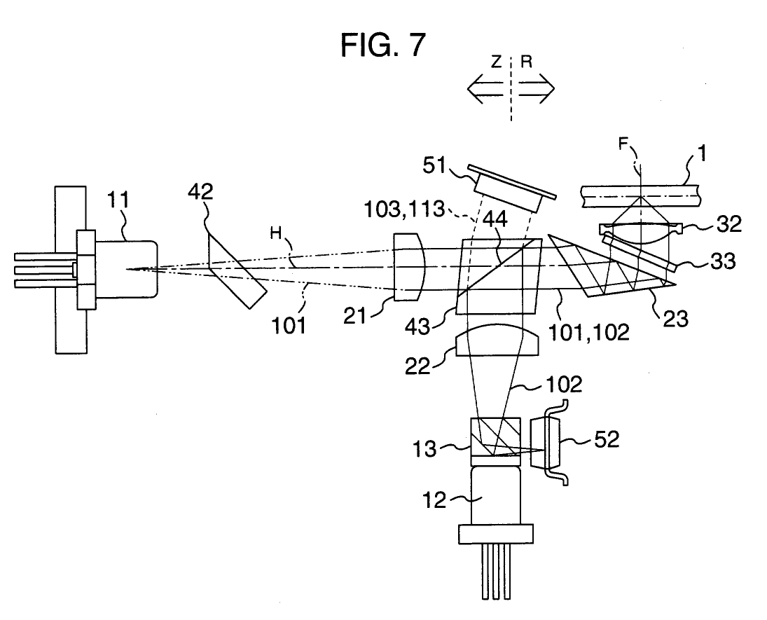

As stated above, the beam splitter 41 formed of a parallel plate has been explained. Alternatively, it has been explained that the parallel plate beam splitter 41 is added thereto with the wedge-like prism. Next, explanation will be made of an embodiment in which the beam splitter 41 is formed into a different shape. FIG. 7 is a view indicating the second embodiment which has the same configuration as that shown in FIGS. 4 and 6, except that a beam splitter 43 is used instead of the beam splitter 41 in this embodiment. Thus, like reference numerals are used to denote like parts to those explained in the embodiment 1 so as to avoid duplicate explanation.

The beam splitter 43 is made of highly transparent resin or optical glass (which will be hereinbelow abbreviated as transparent member), similar to the integrated prism 13. The beam splitter 43 is formed in a rectangular prism shape having a rectangular cross-sectional shape, and is therein formed with a splitting surface 44. Alternatively, a triangular prisms having the splitting surface 44 are joined to each other so as to be formed into a rectangular prism shape. The splitting surface 44 has such a function that transmission and reflection is selectively made in accordance with a light wavelength and a polarizing direction, and is formed through deposition of an optical thin film.

More specifically, the splitting surface 44 constitutes a wavelength selecting film so as to serves as a wavelength selecting means for separating a short wave laser beam and a long wave laser beam from each other. This wavelength selecting film allows not less than 90% of the short wave laser beam (wavelength from 635 to 670 nm for DVD) to transmits therethrough, but reflects not less than 90% of the long wave laser beam (780 nm for CD). Thus, the short wave outgoing light beam A 111 emitted from the LDA 11 is turned into a parallel light beam by the collimator lens 21, transmitting through the separating film 44, and is incident upon the riser prism 23. At this time, a remaining 10% of light is reflected by the splitting surface 44 so as to become a monitor light beam A103 and is then incident upon the PDA 51.

Meanwhile, the long wave outgoing light beam B 111 emitted from the LDB 12 is turned into a parallel light beam by the collimator lens 22, reflecting by the splitting surface 44, and is incident upon the riser prism 23. At this time, the remaining not less than 10% of the light beam transmits through the splitting surface 44 so as to become a monitor light beam B 113 which is incident upon the PDA 51.

As sated above, since a part of the light emission energy of each of both outgoing light beam A 101 and outgoing light beam B111 can be directly monitored by the PDA 51, it is possible to carry out precise recording power control. Further, since the splitting surface 44 has a structure such that it is interposed between highly transparent materials or optical glass materials, a design for formation of the wavelength selecting film formed on the splitting surface 44 becomes simple. Accordingly, the manufacture is simple, and it can be formed at a low cost.

Further, as exaggerated in FIG. 7, an angle of the surface of the rectangular prism is set so that it is slightly inclined to the optical axis, and accordingly, a surface reflection light beam reflected at the front surface of the beam splitter 43 can be led in a direction in which it does not affect the optical system (inter alia, in a direction in which it does not come back to the LDA 11 or the LDB 12). Thus, it is not required to form an antireflection film on the outer surface of the beam splitter 43, and accordingly, the beam splitter 43 can be formed at a low cost.

Further, as exaggerated in FIG. 7, it can be formed such that the rectangular cross-section is elongated along the optical axis of one of the outgoing light beams (in the direction of the optical axis of the incoming light beam A 102 or the incoming light beam B 112 in the embodiment shown in FIG. 7). Thus, with the use of the refractive index of the beam splitter 43, the optical path length can be adjusted.

As detailed hereinabove, there can be provided an optical pick-up apparatus incorporating an optical system which can reproduce or record the CD long wavelength system, and can also reproduce or record the DVD short wavelength system. Further, since at least one of the optical systems is recursive but the other one is nonrecursive, the number of necessary components in the detection system can be reduced while the carriage packaging space can be reduced, thereby it is possible to provide an inexpensive and small-sized optical pick-up apparatus.

Further, due to provision of such a configuration that the third oblique surface 26 of the riser prism 23 and the composite filter 23 is arranged in parallel with each other so as to be opposed to each other, the objective lens 32 and the composite filter 33 can be arranged in close proximity with each other, even allowing the focusing shift of the objective lens, thereby it is possible to provide a thin optical pick-up apparatus. Thus, there can be provided a thin optical pick-up apparatus which can record and reproduce data onto and from not only a low recording density optical disc but also a high recording density optical disc, and a thin optical disc unit using this optical pick-up device.

Thus, according to the present invention, it is possible to provide a thin optical pick-up apparatus which can record and reproduce data to and from each of both low recording density optical disc and high recording density optical disc, and a thin optical disc unit using this pick-up apparatus.

What is claimed is:

1. An optical pick-up apparatus comprising a first light source for emitting a first laser beam having an optical axis and having a first wavelength, a second light source for emitting a second laser beam having an optical axis and having a second wave length, a beam splitter means for guiding the optical axis of the first laser beam and the optical axis of the second laser beam into a common optical axis, a riser prism for turning the common optical axis into an optical axis perpendicular to an optical disc, and an objective lens for focusing the first laser beam and the second laser beam onto the optical disc, characterized in that
a composite filter for controlling diameters and polarizing directions of the first and second laser beams is integrally incorporated with the objective lens, and a surface of the composite filter is opposed to an oblique surface of the riser prism in parallel with each other.

2. An optical pick-up apparatus as set forth in claim 1,characterized in that at least one of the light sources respectively having the first and second wavelengths has an optical power for emitting a laser beam which can record data on the optical disc.

3. An optical pick-up apparatus as set forth in claim 1, characterized in that the riser prism is arranged with a predetermined angle to the common optical axis, having a beam shaping multiplication factor in a range from 1.1 to 1.3.

4. An optical pick-up apparatus as set forth in claim 1, characterized in that the second wavelength is longer than the first wavelength, and an astigmatism correcting member is arranged at a position on the side where the beam having the first wavelength is incident upon the beam splitter means.

5. An optical disc unit characterized by using the optical pick-up apparatus as stated in claim 1.

6. An optical pick-up apparatus comprising a first light source for emitting a first laser beam having an optical axis and having a first wavelength, a second light source for emitting a second laser beam having an optical axis and having a second wave length, a beam splitter means for guiding the optical axis of the first laser beam and the optical axis of the second laser beam into a common optical axis, a riser prism for turning the common optical axis into an optical axis perpendicular to an optical disc, and an objective lens for focusing the first laser beam and the second laser beam onto the optical disc, characterized in that
at least either of the light sources respectively having the first wavelength and the second wavelength has an optical power capable of emitting a laser beam which can record data onto the optical disc, a composite filter for controlling diameters and polarizing directions of the first and second laser beams is integrally incorporated with the objective lens, and a surface of the composite filter is opposed to an oblique surface of the riser prism in parallel with each other.

7. An optical pick-up apparatus as set forth in claim 6, characterized in that the riser prism is arranged with a predetermined angle to the common optical axis, having a beam shaping multiplication factor in a range from 1.1 to 1.3.

8. An optical pick-up apparatus as set forth in claim 6, characterized in that the second wavelength is longer than the first wavelength, and an astigmatism correcting member is arranged at a position on the side where the beam having the first wavelength is incident upon the beam splitter means.

9. An optical disc unit characterized by using the optical pick-up apparatus as stated in claim 6.

10. An optical pick-up apparatus comprising a first light source for emitting a first laser beam having an optical axis and having a first wavelength, a second light source for emitting a second laser beam having an optical axis and having a second wave length which is longer than the first wave length, a beam splitter means for guiding the optical axis of the first laser beam and the optical axis of the second laser beam into a common optical axis, a riser prism for turning the common optical axis into an optical axis perpendicular to an optical disc, an objective lens for focusing the first laser beam and the second laser beam onto the optical disc, a light receiving means for detecting a reflected light beam from the optical disc in response to the first wavelength and second wavelength, and an integrated prism for guiding reflected light beams from the optical disc, having the first wavelength and the second wavelength to the light receiving means characterized in that
the second light source, the integrated prism and the light receiving means are integrally arranged with one another,
the second light source has an optical power capable of emitting a laser beam which can record data onto the optical disc, a composite filter for controlling diameters and polarizing directions of the first and second laser beams is integrally incorporated with the objective lens, and a surface of the composite filter is opposed to an oblique surface of the riser prism in parallel with each other.

11. An optical pick-up apparatus as set forth in claim 10, characterized in that the beam splitter means is composed of a transparent member formed from a parallel plate having one surface on which an optical thin film is formed.

12. An optical pick-up apparatus as set forth in claim 10, characterized in that the beam splitter means is formed from a rectangular prism having a rectangular sectional shape and having therein a splitting surface formed thereon with an optical thin film.

13. An optical pick-up apparatus as set forth in claim 12, characterized in that of the rectangular sectional shape of the beam splitter means is elongated in a direction of a specific optical axis.

14. An optical disc unit characterized by using the optical pick-up apparatus as set forth in claim 10.

15. An optical pick-up apparatus comprising a first light source for emitting a first laser beam having an optical axis and having a first wavelength, a second light source for emitting a second laser beam having an optical axis and having a second wave length which is longer than the first wave length, a beam splitter means for guiding the optical axis of the first laser beam and the optical axis of the second laser beam into a common optical axis, a riser prism for turning the common optical axis into an optical axis perpendicular to an optical disc, an objective lens for focusing the first laser beam and the second laser beam onto the optical disc, a light receiving means for detecting a reflected light beam from the optical disc in response to the first wavelength and second wavelength, and an integrated prism for guiding reflected light beams from the optical disc, having the first wavelength and the second wavelength to the light receiving means characterized in that
the second light source, the integrated prism and the light receiving means are integrally incorporated with one another,
each of the second light source and the second light source has an optical power capable of emitting a laser beam which can record data onto the optical disc, a composite filter for controlling diameters and polarizing directions of the first and second laser beams is integrally incorporated with the objective lens, and a surface of the composite filter is opposed to an oblique surface of the riser prism in parallel with each other.

16. An optical pick-up apparatus as set forth in claim 15, characterized in that the beam splitter means is added thereto with an astigmatism correcting member.

17. An optical pick-up apparatus as set forth in claim 15, characterized in that the beam splitter means is formed from a rectangular prism having a rectangular sectional shape and having therein a splitting surface formed thereon with an optical thin film.

18. An optical pick-up apparatus as set forth in claim 17, characterized in that of the rectangular sectional shape of the beam splitter means is elongated in a direction of a specific optical axis.

19. An optical disc unit characterized by using the optical pick-up apparatus as set forth in claim 15.
